(19) United States
(12) Patent Application Publication
(10) Pub. No.: US 2026/0177163 A1
(43) Pub. Date: Jun. 25, 2026

(54) SOLENOID VALVE

(71) Applicant: ANDREAS LUPOLD HYDROTECHNIK GMBH, Voehringen (DE)

(72) Inventors: Thomas ZEHETBAUER, Feldkirchen am der Donau (AT); Andreas PLOECKINGER, Gunskirchen (AT); Paul FOSCHUM, Linz (AT); Bernd WINKLER, St. Florian (AT); Dieter LOHMILLER, Haigerloch (DE); Marvin SCHELL, Schramberg (DE)

(21) Appl. No.: 18/856,564

(22) PCT Filed: Mar. 27, 2023
(86) PCT No.: PCT/EP2023/057848

§ 371 Date: Oct. 11, 2024

(30) Foreign Application Priority Data
Apr. 12, 2022 (DE) 102022108928.2

(51) Int. Cl. F16K 31/06

(52) U.S. Cl. CPC F16K 31/0665; F16K 31/0693

(57) ABSTRACT

A solenoid valve has a valve body and a valve seat. The valve body can be moved along a travel axis between a closed position and an open position. In the closed position the valve body rests against a valve seat and closes the opening of a media connection and in the open position is lifted off the valve seat and exposes the opening of the media connection. The solenoid valve has an armature and a pole tube. The armature is mounted in the pole tube so that it can move axially between a first and a second end position. The armature occupies the first end position when de-energized and is moved toward the second end position when energized, thus moving the valve body from the closed position towards the open position. The armature is arranged radially outwardly and at least partially axially overlapping with respect to the valve body.

The invention relates to a solenoid valve according to the preamble of claim 1, as is known, for example, from DE 10 2012 019 193 A1.

Such solenoid valves comprise a valve body and a valve seat. The valve body can be moved along a travel axis between the closed position and an open position. In the closed position, the valve body rests against the valve seat and closes the opening of a media connection. In the open position, the valve body is lifted off the valve seat, thereby exposing the opening of the media connection.

The solenoid valve also comprises an armature and a pole tube. The armature is mounted in the pole tube so that it can move axially between a first end position and a second end position. When de-energized, the armature occupies the first end position. When energized, it is moved towards the second end position, causing the valve body to move from the closed position towards the open position.

Such solenoid valves are used for a wide variety of tasks in hydraulics. Since they keep the opening of the media connection closed when no current is applied, they are also called “normally closed” valves.

Further examples of such solenoid valves are known from U.S. Pat. Nos. 5,271,599 A and 5,002,253 A.

Prior art solenoid valves always consist of two separate components, namely the valve assembly enabling the valve function and the electromechanical actuator actuating the valve assembly. The valve assembly and the actuator are cascaded in an axial sequence to form the complete solenoid valve.

However, such solenoid valves have the disadvantage that they require a lot of installation space in the axial direction.

The underlying object of the present invention is therefore to provide a generic solenoid valve which allows a reduction in installation space without negatively affecting the electromechanical properties.

This object is achieved in a generic solenoid valve by the characterizing features of claim 1. Advantageous embodiments of the invention are the subject matter of the dependent claims.

According to the invention, the armature is arranged radially outwardly and at least partially axially overlapping with respect to the valve body, and the valve body is arranged at least partially axially overlapping with respect to the pole tube.

This radially nested structure creates a highly integrated solenoid valve that can be designed to be much more compact than prior art solenoid valves. The actuator thus has the valve body largely integrated, which means that the height of the solenoid valve and also the moved mass can be significantly reduced without negatively affecting the magnetic force and thus the switching characteristics.

Preferably, the armature is designed as a hollow cylinder with a valve body integrated in the interior thereof. This enables particularly simple and effective nesting of the armature and valve body and a strong reduction in the impact energy on the valve seat, since only the valve body strikes it, but the armature is supported on the housing via a special damping system.

A further optimization of the axial height is achieved when the armature and valve body are arranged axially completely within the pole tube.

Further advantageous measures aim to integrate additional functions into the pole tube, which enables an extremely compact design to be implemented.

For example, it may be provided that an armature counterpart is mounted in the pole tube, and the armature, in its first end position, rests thereagainst. The armature counterpart and the valve seat may be formed as one piece, which results in manufacturing advantages.

The armature counterpart may be mounted axially adjustable in the pole tube in order to be able to precisely set and adjust the position of the armature in the first end position. In this case, the armature counterpart can be fixed using at least one securing element, namely in a positive-fit and/or non-positive fit and/or material-fit. In the case of the one-piece design of the armature counterpart and the valve seat, this also applies analogously to the valve seat.

Furthermore, a stroke limiting element, against which the armature rests in the second end position, may be arranged in the pole tube. This allows the switching stroke to be specified exactly. A particularly simple structural design results if the stroke limiting element and the pole tube are embodied in one piece.

Preferably, a spring that preloads the valve body towards the closed position is provided. Furthermore, the armature has a driver which interacts with a corresponding contact surface of the valve body in such a way that, when energized, the armature drives the valve body and lifts it off the valve seat against the preloading of the spring and moves it towards the open position and that, after the energization is switched off, the valve body urges the armature back towards the closed position. This makes it easy to implement the normally-closed function.

There are a variety of design options when it comes to the design of the driver. Particularly preferred is a variant in which the driver is molded on or attached to the end face of the armature as a circumferential collar. Such a flange-like design is simple and inexpensive to manufacture.

The corresponding contact surface can also be easily realized by molding or attaching a circumferential annular surface to the end face of the valve body.

One preferred embodiment provides that the axial position of the armature counterpart in the pole tube is selected such that the valve body, when in the closed position, is mechanically decoupled from the armature, i.e. when the latter occupies the first end position.

This measure aims to increase the service life of the solenoid valve. The wear of the valve body and the valve seat in the region of the opening thus correlates to the number of switching cycles and the magnitude of the impact energy, which is proportional to the product of the moved mass and the speed squared. Especially fast switching times, which require a high armature speed, lead to a conflict of objectives when designing such solenoid valves if a low installation height is to be maintained. Thus, for a given armature stroke, the impact energy can only be reduced by reducing the mass.

In the present case, this is achieved by the valve body being mechanically decoupled from the armature at the time of impact, so that the latter transfers the majority of the impact energy onto the armature counterpart or the valve seat in this region in the case of the one-piece design of the armature counterpart and valve seat. The valve body is designed to be as small and compact as possible so that the load on the valve seat in the region of the opening is essentially determined by the restoring force of the valve spring and the greatly reduced impact energy.

Particularly preferably, in the closed position, the driver and the corresponding contact surface have a minimum axial distance. This ensures that during the closing process the armature can detach from the valve body at the moment the valve body strikes the valve seat in the region of the opening and can still travel a small distance in the form of the residual stroke until it strikes the armature counterpart or the valve seat in this region.

For the opening process, the armature first lifts off the armature counterpart and, after passing through the minimum axial distance, comes into contact with the corresponding contact surface of the valve body via a driver and drives the latter towards the open position. The driver and the corresponding contact surface thus ensure that the valve body is activated during the opening process of the armature and a defined valve opening is made possible.

For the closing process, the current supply is interrupted, whereupon the spring accelerates the valve body towards the valve seat and drives the armature. As soon as the valve body comes into contact with the valve seat in the region of the opening, the armature mechanically detaches from the valve body and moves further towards the armature counterpart or the valve seat. The valve seat therefore experiences only a low impact energy of the lightweight valve body in the area of the opening compared to the impact energy of the armature on the armature counterpart. This ensures a durable design of the solenoid valve.

To protect the armature, damping elements may be provided, for example, acting between armature and armature counterpart and/or between armature and stroke limiting element. In addition, when moving out of the respective end position, the armature is prevented from adhering to the armature counterpart and/or the stroke limiting element.

Known hydraulically acting damping elements in the form of semi-open damping chambers can be used as damping elements, which are formed on or attached to the end face of the armature and/or the armature counterpart and/or the stroke limiting element. The damping chamber may be created by at least one circumferential edge, wherein the armature on the one hand and the armature counterpart and/or the stroke limiting element on the other hand contact one another immediately prior to the contact along the circumferential edge. As the armature approaches, hydraulic fluid is thereby discharged radially in a controlled manner into a return flow channel, resulting in a pressure increase that counteracts the movement, so that the impact energy is damped. Such damping elements are known, for example, from DE 10 2013 220 047 A1.

Alternatively or additionally, it is also possible to realize damping elements as separate elements arranged on the end face of the armature, armature counterpart, and/or stroke limiting element, and having different material properties compared to the armature, armature counterpart, and stroke limiting element. Commonly known materials are used that absorb part of the armature's impact energy to the desired extent.

The inventive design makes it possible to realize hydraulic 2/2-way quick-switching valves which provide a high magnetic force even with a drastically reduced installation height and thus allow high switching dynamics even with large volume flows. Switching times <3 ms can be achieved.

In one embodiment of the invention, it is possible to realize a non-energized closed, non-pressure-equalized 2/2-way seat valve in which the force exerted by the spring onto the valve body is adjustable such that the valve body lifts off the valve seat when a predetermined pressure is exceeded. Thus, the integration of a pressure limiting function is implemented in a non-pressure-equalized 2/2-way seat valve with a low axial height, which is also suitable for high volume flows.

The invention is described in more detail below using an exemplary embodiment. In the figures:

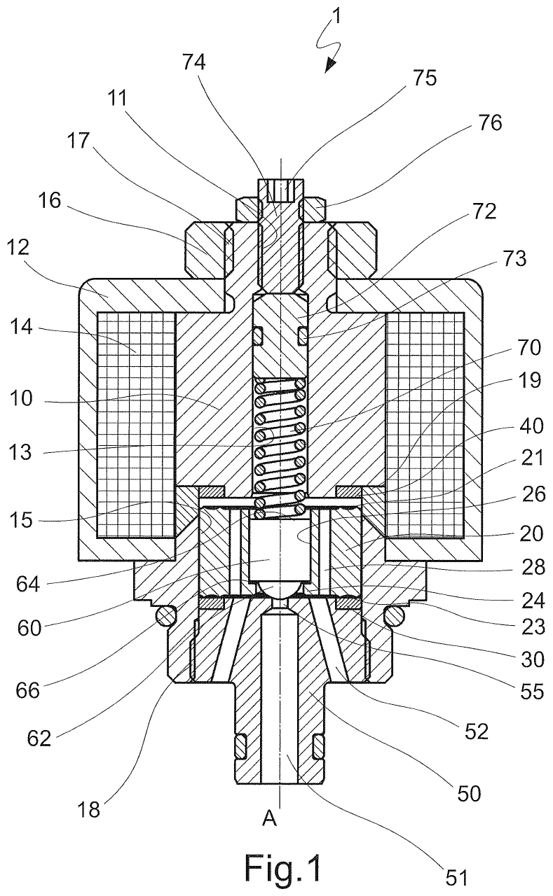

FIG. 1 is an axial section of a solenoid valve according to the invention; and

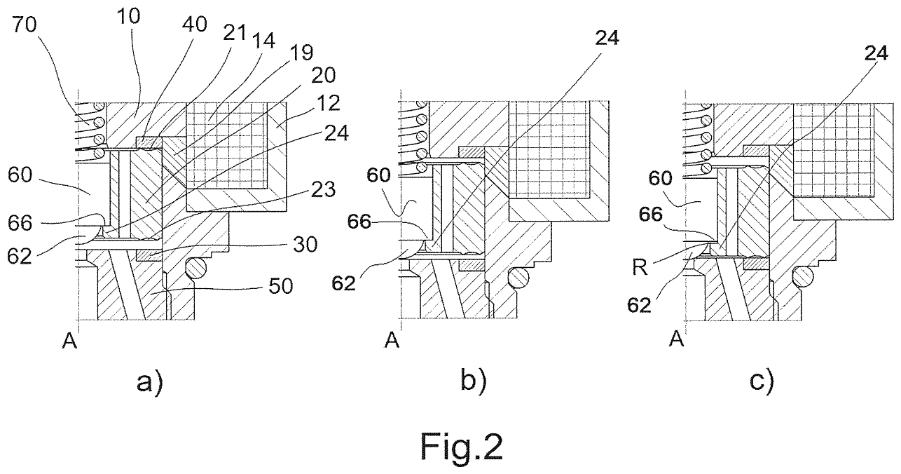

FIG. 2 is an enlarged detailed view in the region of the valve body and its surroundings in axial half-section.

FIG. 1 shows a solenoid valve 1 designed as a normally closed 2/2-way seat valve with pressure relief function.

The solenoid valve 1 has a pole tube 10, which passes completely through the solenoid valve 1 in the axial direction and houses not only the actuators required for actuation, but also the components relevant to the valve function. The pole tube has a non-magnetic part 19 which ensures magnetic decoupling.

A coil 14 is accommodated in a coil housing 12 which is pushed on and supported radially outwardly with respect to the pole tube 10. In the axial direction, the coil housing 12 is secured by a locking element 16 in the form of a nut, which engages with a threaded segment 17 provided in the upper segment of the pole tube 10. At the opposing end, a receiving bore 15 is provided in the pole tube 10 and an [0036] armature 20 is mounted therein so as to be axially displaceable. The receiving bore 15 also accommodates a valve seat 50 which is screwed to the pole tube 10 via a segment having a thread 18.

The valve seat 50 has a first channel 51 as a media connection channel, which passes axially through the valve seat 50 and transitions into an opening 55 on the end face. Furthermore, second channels 52 are present and form a further media channel.

The armature 20 has a central bore 26 and is thus designed as a hollow cylinder. The central bore 26 accommodates the valve body 60 in an axially displaceable manner. The valve body 60 has a dome segment 62 which is oriented against the opening 55 of the valve seat 50. Instead of the dome shape, other shapes known per se, such as conical, round, or flat shapes, can be selected in order to adjust the opening behavior and thus the media flow between the opening 55 and the valve body 60 in accordance with design requirements. Furthermore, pressure equalization channels 28 are provided and axially completely pass through the armature 20.

The valve body 60 is preloaded by a spring 70 towards the opening 55. For this purpose, the spring 70 is accommodated in a receiving bore 13 in the pole tube 10.

The preloading of the spring 70 is adjusted via a support element 72, which is sealed by means of a sealing element 73 and is also accommodated in the receiving bore 13 in an axially displaceable manner. The preloading of the spring 70 is determined by the axial position of the support element 72. An adjusting element 74 in the form of a screw element or threaded pin is inserted in a threaded bore 11 at the upper end of the pole tube 10 and is secured in the desired axial position by means of a fixing element 76. To actuate the adjustment element 74, a hexagon socket 75 is provided here for engaging with a corresponding tool (not shown here).

This exemplary embodiment illustrates that a low installation height of the solenoid valve 1 can be achieved by radially nesting valve body 60 and armature 20 as well as by completely integrating armature 20, valve body 60 and valve seat 50 in the pole tube 10.

The functional sequence during the opening and closing process is explained below.

The valve body 60 is in the closed position in the illustration according to FIG. 1.

For the opening process, the solenoid valve 1 is energized, whereupon the armature 20 moves upwards, driving the valve body 60. For this purpose, a driver 66 in the form of a radially inwardly oriented flange or collar is molded onto the valve body 60 and axially contacts a corresponding contact surface 66 of the valve body 60 and drives the valve body 60 upwards against the action of the spring 70 and finally brings it into axial contact with a stroke limiting element 40. In the present case, the stroke limiting element 40 is mounted in the pole tube 10. It is also possible to integrally mold on the stroke limiting element 40 in the pole tube 10.

In order to close the solenoid valve 1 again, the current supply is switched off, whereby the valve body 60 is forced towards the valve seat 50 by the spring 70. At the same time, as a result of the contact between the contact surface 66 and the driver 24, the armature 20 is dragged downwards so that at the end of the closing process it strikes the armature counterpart 30 which is attached to the end face of the valve seat 50.

A further special feature of the present exemplary embodiment is that the armature 20 is moved even further downwards at the time the valve body 60 strikes the valve seat 50 as a result of the kinetic energy acting on it until it finally strikes the armature counterpart 30. At the time the valve body 60 strikes the valve seat 50 in the region of the opening 55, a mechanical decoupling of the valve body 60 and the armature 20 thus takes place, whereby the impact energy of the valve body 60 is now determined by its energy and the impact energy of the armature 20 is transmitted separately therefrom. This significantly reduces wear, even with high switching cycles and switching forces.

The process of mechanical decoupling of armature 20 and valve body 60 is explained in more detail using the schematic illustration according to FIG. 2, in which different operating states of the solenoid valve 1 are shown in partial illustrations a, b and c. The components and component sections shown in FIG. 2 are designated corresponding to the illustration in FIG. 1. The same reference numerals have the same meaning here as in FIG. 1. However, the individual components are only named in detail with reference signs in FIG. 2a. In FIGS. 2b and 2c, the moving parts are provided with reference signs merely for the sake of clarity.

The illustration in FIG. 2a shows the open state of solenoid valve 1. The driver 24 of the armature 20 has driven the valve body 60 upwards against the force of the spring 70 and maintains this state for the duration of the energization. The dome section 62 is completely lifted off the valve body 50, the fluid can pass through between the valve seat 50 and the valve body 60 at this point.

The armature 20 rests against the pole tube 10 on the end face. A damping chamber 21 in the form of an annular groove with a concave cross-section is provided at this location that displaces hydraulic fluid in a targeted manner when the armature 20 moves into the open position when approaching the opposing end face of the pole tube 10 and thereby dampens the impact.

The illustration in FIG. 2b shows the situation during the onset of the closing process. By switching off the current supply, the spring 70 urges the valve body 60 downwards towards the valve seat 50; the flow cross-section between the dome segment 62 and the valve seat 50 is already reduced. The armature 20 is pulled downwards on the driver 24 via the contact surface 62 of the valve body 60 and has detached from the axial contact with the pole tube 10 in the position shown.

The illustration according to FIG. 2c shows the final state in which the valve body 60 rests with its the dome segment 62 on the valve seat 50 in the region of the opening 55 and has thus reached the closed position. After the valve body 60 has struck the valve seat 50 in the region of the opening 55, the armature 20 has detached from the valve body 60 and reached its final position by striking the armature counterpart 30. In this region, too, a concave annular structure with a defined outlet in the form of the damping chamber 23 is formed to dampen the impact of the armature 20.

In this position, the axial distance between the driver 24 and the corresponding contact surface 66 can be clearly seen in the form of the residual stroke R, which ensures a secure mechanical decoupling of the armature 20 and valve body 60. The impact energy acting on the valve seat 50 in the region of the opening 55 is limited to the impact energy of the valve body 60, which, due to its low mass, results in little wear, even at high speeds. The majority of the impact energy is dissipated on the side of the mechanically decoupled armature 20 when it strikes the armature counterpart 30. This is a region that can be dimensioned so that the kinetic energy of the armature 20 can be absorbed there.

The pressure limiting function can also be derived from the illustrations in FIG. 2.

The initial situation is now the situation shown in FIG. 2c, in which the state of a closed valve is shown.

When a predetermined limit pressure is exceeded in the first channel 51, the valve body 60 is displaced upwards against the preload force of the spring 70, whereby the medium can pass through the region of the opening 55 and flow out laterally. Due to the mechanical decoupling of valve body 60 and armature 20, the latter remains in its initial position so that the pressure limiting function can be designed to be operationally safe without additional measures. As already explained in connection with FIG. 1, the preload force of the spring 70 required for the pressure limiting function can be adjusted via the adjusting element 74.

### LIST OF REFERENCE SIGNS

1 Solenoid valve
10 Pole tube
11 Threaded bore
12 Coil housing
13 Receiving bore
14 Coil
15 Receiving bore
16 Securing element
17 Threaded segment
18 Thread-bearing segment
19 Non-magnetic pole tube part
20 Armature
21 Damping chamber
23 Damping chamber
24 Driver
26 Central bore
28 Pressure relief channel
30 Armature counterpart
40 Stroke limiting element
50 Valve seat
51 First channel
52 Second channel
55 Opening
60 Valve body
62 Dome segment
64 End face
66 Contact surface
70 Spring
72 Support element
73 Sealing element
74 Adjustment element
75 Hexagon socket
76 Fixing element
A Travel axis
R Remaining stroke

1. A solenoid valve (1) comprising a valve body (60) and a valve seat (50), wherein
the valve body (60) is movable along a travel axis (A) between a closed position and an open position,
in the closed position, the valve body (60) rests against a valve seat (50) and closes the opening (55) of a media connection (51), and, in the open position, is lifted off the valve seat (50), thereby releasing the opening (55) of the media connection (51),
comprising an armature (20) and a pole tube (10), wherein
the armature (20) is mounted in the pole tube (10) so that it is axially movable between a first and a second end position,
the armature (20) occupies the first end position when de-energized, and is moved towards the second end position when energized, thus moving the valve body (60) from the closed position towards the open position,
characterized in that
the armature (20) is nested radially outwardly with respect to the valve body (60) and is arranged at least partially axially overlapping, and
the valve body (60) is arranged at least partially axially overlapping with respect to the pole tube (10).

2. The solenoid valve (1) according to claim 1, characterized in that the armature (20) is designed as a hollow cylinder with the valve body (60) integrated in the interior thereof.

3. The solenoid valve (1) according to claim 1, characterized in that
the armature (20) and the valve body (60) are arranged axially completely within the pole tube (10).

4. The solenoid valve (1) according to claim 1, characterized in that an armature counterpart (30) is mounted in the pole tube (10), and the armature (20) in its first end position rests thereagainst.

5. The solenoid valve (1) according to claim 4, characterized in that the armature counterpart (30) and the valve seat (50) are formed as one piece.

6. The solenoid valve (1) according to claim 4, characterized in that the armature counterpart (30) is mounted axially adjustably in the pole tube (10).

7. The solenoid valve (1) according to claim 4, characterized in that the armature counterpart (30) is fixed or is fixable in a positive fit and/or non-positive fit and/or material fit using at least one securing element.

8. The solenoid valve (1) according to claim 1, characterized in that
a stroke limiting element (40) is mounted in the pole tube (10), against which the armature (20) rests in the second end position.

9. The solenoid valve (1) according to claim 8, characterized in that
the stroke limiting element (40) and the pole tube (10) are embodied in one piece.

10. The solenoid valve (1) according to claim 1, characterized in that
a spring (70) that preloads the valve body (60) towards the closed position is provided, and the armature (20) has a driver (24) which interacts with a corresponding contact surface (66) of the valve body (60) in such a way that, when energized, the armature (20) drives the valve body (60) and lifts it off the valve seat (50) against the preloading of the spring (70) and moves it into the open position, and
after the energization is switched off, the valve body (60) urges the armature (20) back towards the closed position.

11. The solenoid valve (1) according to claim 10, characterized in that the driver (24) is molded on or attached to the end face of the armature (20) as a circumferential collar.

12. The solenoid valve (1) according to claim 10, characterized in that
the contact surface (66) is molded on or attached to the end face of the valve body (60) as a circumferential annular surface.

13. The solenoid valve (1) according to claim 10, characterized in that
the axial position of the armature counterpart (30) in the pole tube (10) is selected such that the valve body (60), when in the closed position, is mechanically decoupled from the armature (60) when the latter occupies the first end position.

14. The solenoid valve (1) according to claim 13, characterized in that
the driver (24) and the corresponding contact surface (66) can have a minimum axial distance in order to ensure a residual stroke (R) of the armature (20) when the valve body (60) strikes the valve seat (50) in the region of the opening (55) until it strikes the armature counterpart (30) or the valve seat (50) in the region of the integrally formed armature counterpart (30).

15. The solenoid valve (1) according to claim 13, characterized in that
a damping element acting between the armature (20) and the armature counterpart (40) and/or between the armature (20) and the stroke limiting element (40) is provided.

16. The solenoid valve (1) according to claim 15, characterized in that the damping element or elements are designed as semi-open damping chambers (21, 23) attached to the end face of the armature (20) and/or the armature counterpart (30) and/or the stroke limiting element (40).

17. The solenoid valve (1) according to claim 16, characterized in that the damping chamber (21, 23) is formed by at least one circumferential edge, and the armature (20) on the one hand and the armature counterpart (30) and/or the stroke limiting element (40) on the other hand contact one another along the circumferential edge.

18. The solenoid valve (1) according to claim 15, characterized in that the damping element(s) are embodied as separate elements arranged on the end face of the armature (20), armature counterpart (30), and/or stroke limiting element (40), and that have different material properties than the armature (20), the armature counterpart (30), or the stroke limiting element (40).

19. The solenoid valve (1) according to claim 1, characterized in that
it is designed as a non-energized closed, non-pressure-equalized 2/2-way seat valve, and the force exerted by the spring (70) onto the valve body (60) is adjustable such that the valve body (60) lifts off the valve seat (50) when a predetermined pressure is exceeded.
